(19) United States
(12) Patent Application Publication
(10) Pub. No.: US 2013/0027943 A1
(43) Pub. Date: Jan. 31, 2013

(54) LIGHTING APPARATUS

(71) Applicants: Wakaaki Itohara, Osaka-shi (JP); Yutaka Takashige, Osaka-shi (JP); Hirotsugu Fukumoto, Osaka-shi (JP)

(72) Inventors: Wakaaki Itohara, Osaka-shi (JP); Yutaka Takashige, Osaka-shi (JP); Hirotsugu Fukumoto, Osaka-shi (JP)

(73) Assignee: SHARP KABUSHIKI KAISHA, Osaka-shi, Osaka (JP)

(21) Appl. No.: 13/641,008

(22) PCT Filed: Apr. 1, 2011
(86) PCT No.: PCT/JP2011/058387

§ 371 Date: Oct. 12, 2012

(30) Foreign Application Priority Data
Apr. 14, 2010 (JP) 2010-093427

(51) Int. Cl. F21V 13/12; F21V 13/02

(52) U.S. Cl. 362/260

(57) ABSTRACT

A lighting apparatus includes an LED provided with a light-emitting device and phosphor excited by light emitted from the light-emitting device to emit excitation light. A shielding part (for example, a mounting part (a base surface) of the LED and an erecting part) is provided in a region where light with chromaticity different from chromaticity being visible due to the light from the light-emitting device and the excitation light is radiated, the shielding part shielding the light with different chromaticity among lights radiated from the LED. The color unevenness caused by the illumination of the light with different chromaticity is reduced.

This application is the national phase under 35 U.S.C. §371 of PCT International Application No. PCT/JP2011/058387 which has an International filing date of Apr. 1, 2011 and designated the United States of America.

### BACKGROUND

1. Technical Field

The present invention relates to a lighting apparatus provided with a light source including a light-emitting device and phosphor emitting excitation light, which is excited by light emitted from the light-emitting device.

2. Description of Related Art

In recent years, a lighting apparatus, in which a light-emitting diode (hereinafter referred to as the “LED”) as a light-emitting device is utilized as a light source, is widely used (for example, see Japanese Patent Application Laid-Open No. 2009-206062). In the lighting apparatus described in Japanese Patent Application Laid-Open No. 2009-206062, an LED substrate on which a plurality of LEDs are mounted is attached to a base surface of a frame body, and a diffusion plate is provided opposite to the base surface in parallel. Accordingly, light emitted from the LED is directly radiated perpendicular to the diffusion plate, and the light is diffused by the diffusion plate and then a living space such as indoor with a lighting apparatus is illuminated.

A so-called surface-mount type pseudo-white LED in which a blue LED device is sealed by resin containing yellow phosphor that is excited (is converted in wavelength) by light emitted from the blue LED device to emit yellow light, and an incandescent LED in which red phosphor that is excited by the light emitted from the blue LED device to emit red light is further contained in the resin, are publicly known as LED.

### SUMMARY

However, in a case where an LED such as the pseudo-white LED provided with an LED device and phosphor excited by the light emitted from the LED device to emit excitation light is used, some problems occur as described below.

The LED including an LED device and phosphor forms a region in which light with desired chromaticity such as white light emitted from the pseudo-white LED is visible and a region in which light with chromaticity different from the desired chromaticity is visible, as the illumination region. The light with different chromaticity radiated in the region is either light with strong tint of the excitation light or light with strong tint of the light from the LED device.

The light with strong tint of the excitation light appears because the ratio of wavelength conversion of light emitted from the light-emitting device through the phosphor becomes larger in the direction of radiation where the amount of light emitted from the LED device becomes lower or in the direction of radiation where the pathway in which the light emitted from the LED device passes through the resin containing the phosphor becomes longer. Additionally, the light with strong tint of the light from the LED device appears because the ratio of wavelength conversion of light emitted from the light-emitting device through the phosphor becomes smaller in the direction of radiation where the amount of light emitted from the LED device becomes higher or in the direction of radiation where the pathway in which the light emitted from the LED device passes through the resin containing the phosphor becomes shorter.

For this reason, with regard to the lighting apparatus using an LED provided with an LED device and phosphor as the light source, in the illumination region, the region in which the light with desired chromaticity is visible and the region in which the light with chromaticity different from the desired chromaticity is visible are formed in mixture, so the problem of color unevenness occurs. Specifically, in a case where the pseudo-white LED is used as the light source, a part of the diffusion plate of the lighting apparatus becomes yellowish (or bluish) caused by yellowish (or bluish) white light different from the desired white light. Additionally, in a case where a lighting apparatus with the pseudo-white LED as the light source is installed on ceiling plane in the house or the like, the yellowish (or bluish) white light is illuminated on the ceiling plane at the periphery of the lighting apparatus. Hence, the mirroring phenomenon such as ceiling plane becoming yellowish (or bluish) occurs, and the region in which the yellowish (or bluish) white light is visible and the region in which the desired white light is visible are mixed so that the color unevenness occurs.

In view of such circumstances, the present invention aims to provide a lighting apparatus, which can reduce color unevenness.

A lighting apparatus according to the present invention is a lighting apparatus comprising a light source provided with a light-emitting device and phosphor excited by light emitted from the light-emitting device to emit excitation light, wherein a shielding part is provided in a region where light with chromaticity different from chromaticity being visible due to the light from the light-emitting device and the excitation light is radiated, the shielding part shielding the light with different chromaticity among lights radiated from the light source.

According to the lighting apparatus related to the present invention, the color unevenness caused by the light with different chromaticity is reduced because the light with chromaticity different from chromaticity being visible due to the light from the light-emitting device and the excitation light is shielded by the shielding part.

The lighting apparatus according to the present invention is a lighting apparatus comprising light source provided with a light-emitting device and a phosphor excited by light emitted from the light-emitting device to emit excitation light, wherein a shielding part is provided in an illumination region illuminated by the light source, in order to reduce formation of an illumination region illuminated by light with chromaticity different from chromaticity being visible due to the light from the light-emitting device and the excitation light, the shielding part shielding the light with different chromaticity.

According to the lighting apparatus related to the present invention, the formation of illumination region illuminated by the light with different chromaticity can be reduced and the color unevenness can be reduced, because the light with chromaticity different from chromaticity being visible due to the light from the light-emitting device and the excitation light is shielded by the shielding part.

The lighting apparatus according to the present invention is a lighting apparatus comprising a light source provided with a light-emitting device and phosphor excited by light emitted from the light-emitting device to emit excitation light, wherein a shielding part is provided in an illumination region illuminated by the light source, in order to reduce a color unevenness caused by an illumination of light with chromaticity different from chromaticity being visible due to the light from the light-emitting device and the excitation light, the shielding part shielding the light with different chromaticity.

According to the lighting apparatus related to the present invention, the color unevenness caused by the illumination of the light with different chromaticity is reduced because the light with chromaticity different from chromaticity being visible due to the light from the light-emitting device and the excitation light is shielded by the shielding part.

The lighting apparatus according to the present invention includes a frame body for installing the light source inside, and the shielding part is formed as a part of the frame body.

According to the lighting apparatus related to the present invention, the shielding part is facilitated by configuring a part of the frame body, the shielding part can be easily provided.

In the lighting apparatus according to the present invention, the frame body includes a mounting part for mounting the light source and an erecting part vertically arranged with respect to the mounting part, and the light source is attached inclinedly relative to the mounting part or the erecting part in order to shield the light with different chromaticity at the mounting part or the erecting part.

According to the lighting apparatus related to the present invention, the light source is attached inclinedly with respect to the mounting part or the erecting part, and it is possible to reduce the color unevenness caused by the light with different chromaticity by shielding the light with different chromaticity at the mounting part or the erecting part.

The lighting apparatus according to the present invention includes a diffusion part diffusing light emitted from the light source at the side radiated by the light from the light source, and the frame body forms a concavity at the mounting part and/or the erecting part in order to keep the light source distant away from the diffusion part.

According to the lighting apparatus related to the present invention, the diffusion part is provided for diffusing the light emitted from the light source at the side radiated by the light from the light source. Since the concavity is formed at the mounting part and/or the erecting part provided for the purpose of keeping the light source distant away from the diffusion part, the present invention is able to make the distance between the light source and the diffusion part longer by placing the light source at the concavity, and uniform plane emission is obtained in the whole region of the diffusion part.

According to the present invention, it is possible to reduce the color unevenness.

The above and further objects and features will more fully be apparent from the following detailed description with accompanying drawings.

### BRIEF DESCRIPTION OF THE DRAWING

FIG. 1 is a plan view of a lighting apparatus of the present invention.

FIG. 2 is a perspective view of the lighting apparatus of FIG. 1 in the condition of a center cover being removed.

FIG. 3 is a perspective view of the lighting apparatus of FIG. 1 in the condition of both the center cover and a diffusion panel being removed.

FIG. 4 is an exploded perspective view of the lighting apparatus of FIG. 1.

FIG. 5 is a cross-sectional view of the lighting apparatus of FIG. 1 in the lateral direction that passes through a side cover.

FIG. 6 is a schematic view illustrating chromaticity of the illumination region illuminated by light emitted from an LED in the lighting apparatus of the present invention.

FIG. 7 is a schematic view illustrating chromaticity of the illumination region illuminated by light emitted from an LED in a lighting apparatus of a comparative example.

### DETAILED DESCRIPTION

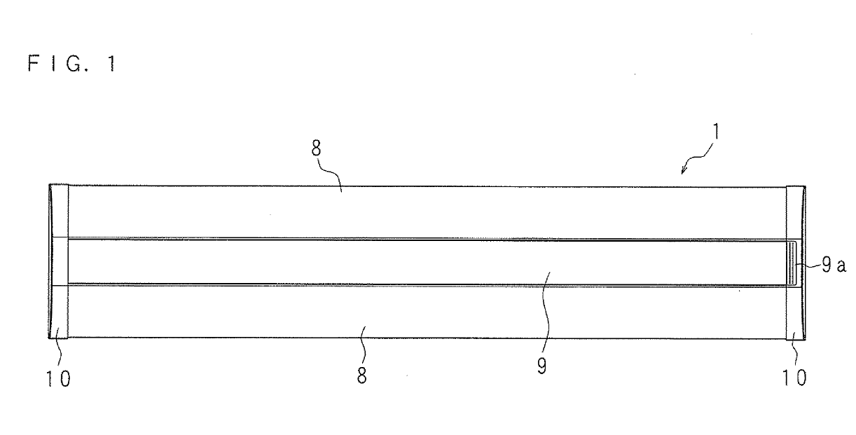

The present invention is more readily described with reference to the drawings. FIGS. 1 to 5 illustrate a lighting apparatus of the present invention. FIG. 1 is a plan view of the lighting apparatus.

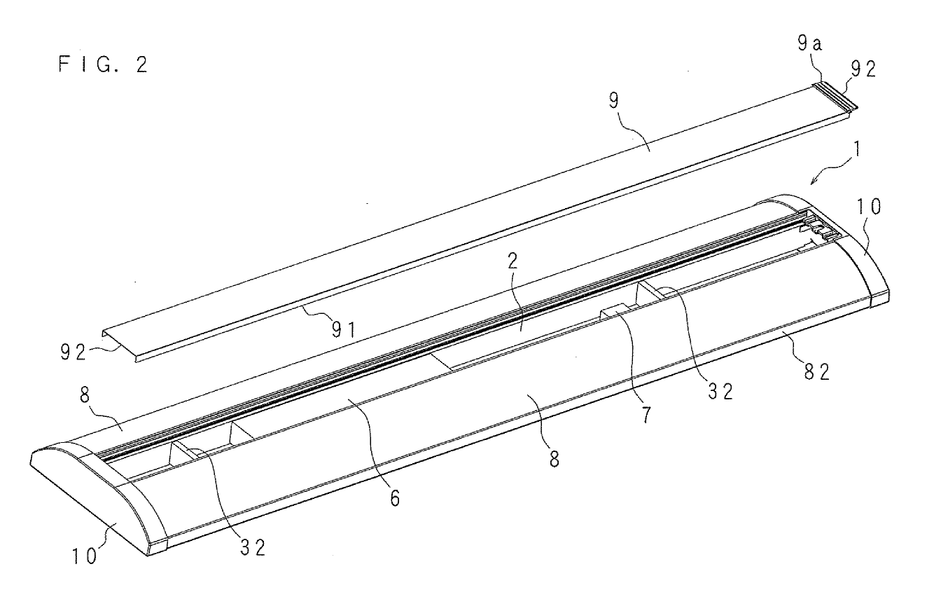

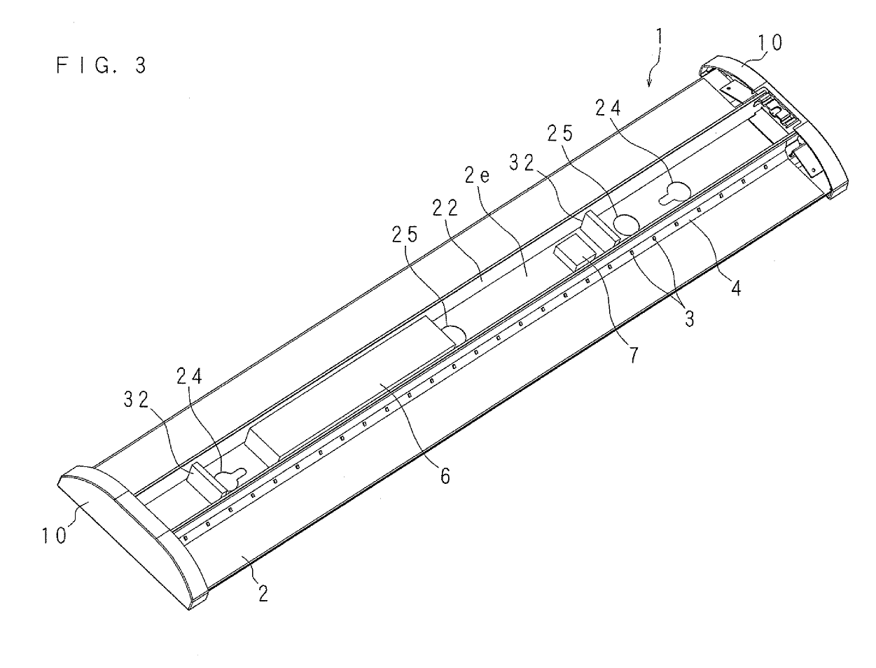

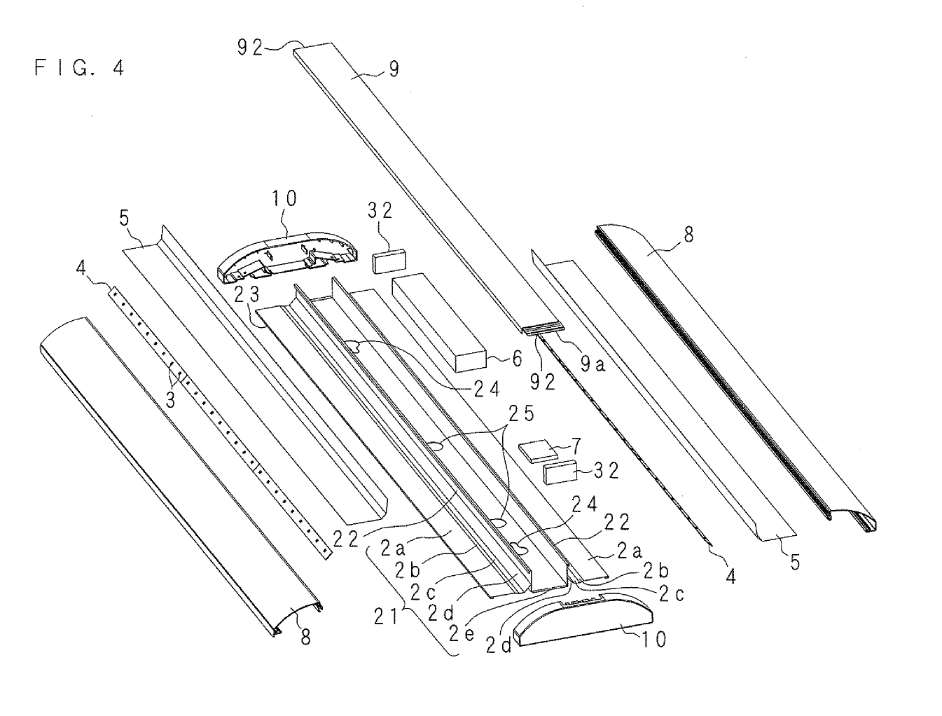

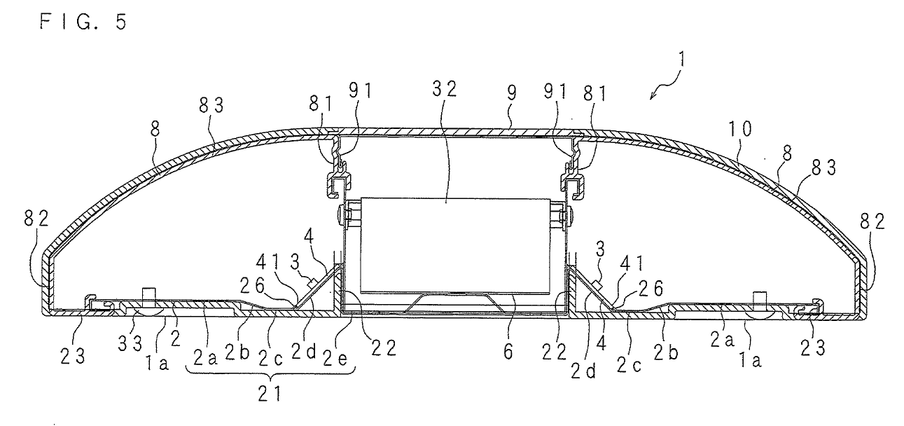

FIG. 2 is a perspective view of the lighting apparatus of FIG. 1 in the condition of a center cover being removed. FIG. 3 is a perspective view of the lighting apparatus of FIG. 1 in the condition of both the center cover and a diffusion plate being removed. FIG. 4 is an exploded perspective view of the lighting apparatus of FIG. 1. FIG. 5 is a cross-sectional view of the lighting apparatus of FIG. 1 in the lateral direction that passes through a side cover.

As illustrated in FIG. 4, a lighting apparatus 1 includes a lengthy base frame 2 as a frame body for placing an LED 3 inside; LED substrates 4, 4 on which a plurality of LEDs 3 as the so-called surface-mount type pseudo-white LED in which a blue LED device is sealed by resin containing yellow phosphor are mounted; reflection sheets 5, 5 for reflecting light emitted from the LED 3; a power unit 6 for supplying power to the LED 3; a connecting terminal 7 connected to an electric wire provided by a commercial power; diffusion plates 8, 8 as the diffusion part for diffusing the light emitted from the LED 3 and radiating the diffused light to outside; a center cover 9 arranged along the longitudinal direction of the base frame 2 and covering the power unit 6, the connecting terminal 7 and the like; and side covers 10, 10 attached to the both end portions in the longitudinal direction of the base frame 2.

As shown in FIG. 5, the base frame 2 forms a symmetrical shape with reference to the center in its lateral direction. The base frame 2 includes a base surface 21 as a mounting part of the LED 3 and erecting parts 22 vertically arranged with respect to the base surface 21. The base surface 21 is extended from the side of edge portions 23, 23 to the center side. The base surface 21 includes first base surfaces 2a, 2a being substantially parallel to an installation surface 1a of the lighting apparatus 1 in FIG. 5; first inclined parts 2b, 2b connected to the first base surfaces 2a, 2a and inclined with respect to the side of the installation surface 1a of the lighting apparatus 1; second surfaces 2c, 2c connected to the first inclined parts 2b, 2b and being parallel to the installation surface 1a of the lighting apparatus 1; second inclined parts 2d, 2d connected to the second base surfaces 2c, 2c and inclined to the opposite side of the installation surface 1a of the lighting apparatus 1; and third base surface 2e connected to the after-mentioned erecting parts 22, 22 and being parallel to the installation surface 1a of the lighting apparatus 1. The erecting parts 22, 22 are connected to the second inclined parts 2d, 2d and vertically arranged with respect to the base surface 21 as the mounting part of the LED 3.

Installation holes 24, 24 for installing the base frame 2 to the installation location such as ceiling or wall are formed on the third base surface 2e of the base frame 2. Providing the installation holes 24, 24 for installation is one of the examples, and it is not limited to this case. When the base frame 2 can be installed at a desired location, a member such as hook may be used. Additionally, wiring holes 25, 25 for wiring a power line and the like to an appropriate location are formed on the third base surface 2e.

The lengthy rectangular LED substrate 4 is attached to the second inclined part 2d of the base frame 2. Additionally, a plurality of LEDs 3 are mounted on the LED substrate 4 with arranged in sequence with equal interval. Accordingly, the normal direction of the LED substrate 4 does not coincide with the normal direction of the base surface 21 as the mounting part of the base frame 2 on which the LED 3 is mounted and with the normal direction of the erecting part 22. The LED 3 as the light source, which is mounted on the LED substrate 4, is attached inclinedly with respect to the base surface 21 as the mounting part for the LED 3 and the erecting part 22. The interval of the arrangement of the plurality of LEDs 3 mounted on the LED substrate 4 can be alternately changed according to the luminance unevenness of the light emitted from each LED 3 and the like, and the equal interval may not be necessary.

Each LED 3 is a pseudo-white light source having both a blue LED device as the light-emitting device and yellow phosphor as the phosphor that is excited by the light emitted from the light-emitting device to emit the excitation light. For example, each LED 3 is a surface-mount type LED equipped with a blue LED device, sealing resin which seals the blue LED device and in which yellow phosphor is scattered, and both of an input terminal and an output terminal. According to this pseudo-white light source, a part of the light emitted from the blue LED device is excited (is converted in wavelength) through yellow phosphor and then the yellow excitation light is emitted and radiated, and then the white light with desired chromaticity is visible due to both of the excitation light and the blue light emitted from the blue LED device.

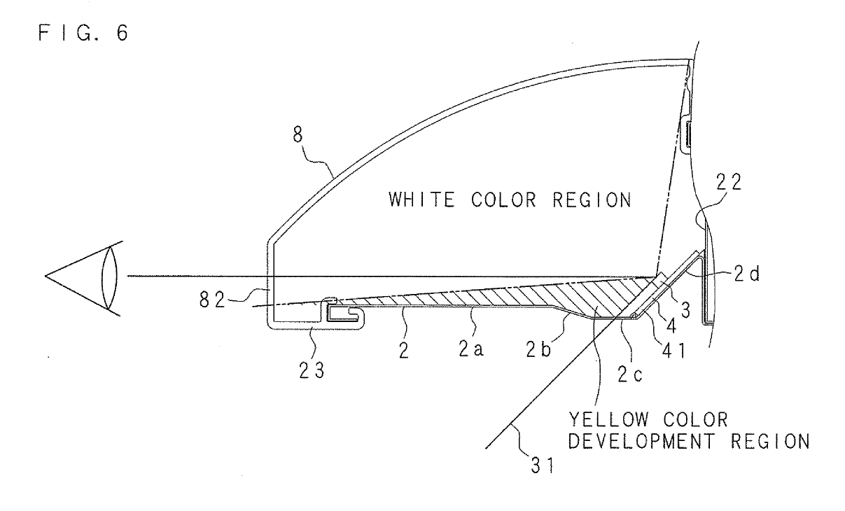

However, with regard to the LED as the light source having both of the light-emitting device and the phosphor that is excited by the light emitted from the light-emitting device to emit the excitation light, in the direction of radiation where the amount of light from the light-emitting device becomes lower and in the direction of radiation where the pathway in which the light emitted from the light-emitting device passes through resin containing the phosphor becomes longer, the ratio of wavelength conversion of light emitted from the light-emitting device due to the phosphor becomes larger and the light with chromaticity different from chromaticity being visible due to the light from the light-emitting device and the excitation light is radiated. According to the general surface-mount type LED, because the amount of light radiated in the direction of radiation close to the light-emitting surface of an LED becomes lower and the pathway in which the light emitted from the light-emitting device passes through resin containing phosphor becomes longer, as described below with the reference to FIG. 6, the light with different chromaticity (the light in the yellow color development region marked with hatching in FIG. 6) is radiated in the direction of radiation close to a light-emitting surface 31 of the LED 3 in FIG. 6.

Accordingly, in the present embodiment, with regard to the illumination region illuminated in the direction of radiation close to the light-emitting surface 31 of the LED 3 in FIG. 6, in order to reduce the color unevenness due to yellowish white light as the light with different chromaticity, the LED 3 (the LED substrate 4) is arranged inclinedly with respect to the base surface 21 and the erecting part 22 as the shielding part for shielding the light with different chromaticity. Herewith, the yellowish white light is radiated along the base surface 21 and the erecting part 22 as the shielding part, as described below, and the light is shielded by the base surface 21 and the erecting part 22 before the light reaches the diffusion panel 8 so that the appeared color unevenness caused by the illumination of the yellowish white light can be reduced.

To achieve the arrangement for stabilizing the LED substrate 4 on the mounting part for the LED 3 (the second inclined part 2d) of the base frame 2, a stopper 26 including a concavity for position alignment is provided at the boundary between the second base surface 2c and the second inclined part 2d (see FIG. 5). Therefore, the arrangement and fixing operation of the LED substrate 4 is facilitated because a bottom edge 41 of the LED substrate 4 attached to the second inclined part 2d can be prevented from slipping due to the stopper 26.

The reflection sheet 5 is provided for radiating the light emitted from the LED 3 efficiently to the diffusion panel 8. By matching and attaching the both edges of the reflection sheet 5 to the both edges of the diffusion panel 8, the leakage of the light emitted from the LED 3 towards inside the lighting apparatus 1 is suppressed and then the luminous efficiency of radiation towards outside the lighting apparatus 1 is increased. When a processing such as coating is applied on the LED substrate 4 and the base frame 2 for fully reflecting the light emitted from the LED 3, it is not necessary to provide the reflection sheet 5.

The power unit 6 and the connecting terminal 7 are housed and the LED substrates 4, 4 are provided side-by-side in the space pinched by two erecting parts 22, 22 of the base frame 2. In other words, both the power unit 6 and the connecting terminal 7 are pinched between two erecting parts 22, 22, and the LED substrates 4, 4 are separated at two locations and placed side-by-side at outer side of the erecting parts 22, 22 of the base frame 2. Since the installation location of the LED substrate 4 is close to the power unit 6, in order to prevent the heat conduction to the LED 3 influenced by the power unit 6, it is preferable to provide a thermal insulation member for insulating heat conduction from the power unit 6 to the LED 3 between the power unit 6 and erecting parts 22. Moreover, in order to perform better heat conduction from the LED 3, it is preferable to provide a heat radiation sheet between the LED substrates 4, 4 and the second inclined part 2d.

Both ends of the first base surface 2a of the base frame 2 in the longitudinal direction and the side cover 10 are fixed by a screw 33. The screw 33 also functions as a heat radiator that radiates the heat from the LED 3 or the power unit 6. As shown in FIG. 5, with regard to the base frame 2 for placing the LED substrate 4, the screw 33 is housed in the space formed between the base surface 21 of the base frame 2 and the installation surface 1a for preventing the detachment of the screw 33 from the installation surface 1a of the lighting apparatus 1; therefore, the base surface 21 of the base frame 2 is hollow at the side of the installation surface 1a so that the first inclined part 2b, the second base surface 2c and the second inclined part 2d can be provided.

Accordingly, in order to keep the LED 3 distant away from the diffusion panel 8, in the concavity constituted by the first inclined part 2b, the second surface 2c and the second inclined part 2d and formed in the mounting part for the LED 3, the distance between the LED 3 and diffusion panel 8 can be extended by attaching the LED substrate 4 on which the LED 3 is mounted to the second inclined part 2d. In other words, by placing the LED 3 in the concavity, the LED 3 can be arranged to keep distant away from the diffusion panel 8 so that the light radiated from the LED 3 is diffused uniformly by the diffusion panel 8 and hence plane emission is achieved.

Other than utilizing the housing space for housing the screw 33 in the present embodiment, in order to cover the unevenness such as burr existed at an installation section such as ceiling or wall for installing the lighting apparatus, the concavity may be formed in using the covering space in the case where a covering space between the installation surface of the lighting apparatus and the installation section is provided. In other words, the concavity may be formed in using the space existing between the installation surface of the lighting apparatus and the installation section of the lighting apparatus such as ceiling or wall. Additionally, the concavity is formed as the installation surface of the lighting apparatus overhangs at the side of the installation section of the lighting section, the space (hole, groove and the like) for fitting the overhanging concavity to the installation section such as ceiling or wall is provided and then the lighting apparatus may be installed.

As shown in FIG. 5, the center cover 9 is provided for covering the space pinched by erecting parts 22, 22. Both end portions 91, 91 in the lateral direction of the center cover 9 are engaged with engaging parts 81, 81 of the diffusion panels 8, 8 at the center of the lighting apparatus 1, and the both edge portions 92, 92 in the longitudinal direction of the center cover 9 are fixed to the side covers 10, 10. With regard to one edge portion of the center cover 9, the one end portion is slid and inserted into the side cover 10 by means of providing a fixable fixing member 9a at the side cover 10.

In the condition of removing the center cover 9, the lighting apparatus 1 is installed at the installation section such as ceiling or wall. After the installation, the both end portions 91, 91 in the lateral direction of the center cover 9 are engaged to the engaging parts 81, 81 of the diffusion panel 8, then the both end portions 92, 92 in the longitudinal direction of the center cover 9 are inserted and fixed into the side covers 10, 10 through the fixing member 9a so that it is possible to install the center cover 9 to the lighting apparatus 1. With regard to the center cover 9, in order to prevent reflecting on the diffusion panel 8 the shadow of the interior configured members projected by the light emitted from the LED 3, it is preferable to have a certain width of the center cover 9 to shield the shadow.

The diffusion panels 8, 8 as the diffusion part for diffusing the light emitted from the LED 3 are placed at the side radiated by the light emitted from the LED 3. As shown in FIG. 5, the cross section of the diffusion panels 8, 8 form a dome shape in the lateral direction of the lighting apparatus 1. The center cover 9 is pinched between the diffusion panels 8, 8, and the diffusion panels 8, 8 are attached to two sides of the base frame 2 symmetrically. For diffusing the light emitted from the LED 3 by the whole surface of the diffusion panels 8, 8, the scattering dispersion of the radiated light emitted from each LED 3 is suppressed and hence the plane emission with uniform luminance at the diffusion panels 8, 8 can be achieved.

Although the diffusion panels 8, 8 are formed in a dome shaped, only the edge portions 82, 82 at the side of lateral edge portions 23, 23 of the base frame 2 form planar shapes perpendicular to the installation surface 1a. As differ from the case where the curved surfaces of the diffusion panels 8, 8 form dome shapes completely, the line of flexure of the boundary between the edge portion 82 and the curved surface 83 of the diffusion panel 8 is visible to the user. Therefore, the user get a view of the lighting apparatus 1 becoming slimmer when the lighting apparatus 1 is installed at ceiling or the like. To make the distance between the diffusion panel 8 and the LED 3 as longer as possible, it is preferable that the shapes of the curved surfaces 83, 83 of the diffusion panels 8, 8 nearly form arc-like shapes as the LED 3 is referenced as the center.

The center cover 9 (the power unit 6 and the connecting terminal 7) is pinched between two LED substrates 4, 4 and between two diffusion panels 8, 8. Two LED substrates 4, 4 and two diffusion panels 8, 8 are provided at both sides of the lighting apparatus 1, respectively. Two LED substrates 4, 4 are attached to the second inclined parts 2d, 2d such that two LED substrates 4 are inclined with respect to the base surface 21 for the purpose of turning the direction of light radiated from the LEDs 3 mounted on the LED substrates 4, 4 toward outside in opposite direction. In a case where the lighting apparatus 1 is installed at ceiling plane, the light is radiated to outside diagonally from both sides of the lighting apparatus 1 in the lateral direction. Therefore, the light distribution of the illumination region can be broadened as compared with the lighting apparatus in which the light is radiated vertically from the attached light source facing the base surface 21 in parallel.

The distance between the erecting parts 22, 22 of the base frame 2 is isolated in the appropriate length, grips 32, 32 are perpendicular to the erecting parts 22, 22, and the grips 32, 32 are provided to couple with the erecting parts 22, 22. The user operating the installation can only hold the grips 32, 32 and install the base frame 2 at the installation location such as ceiling or wall so that installing the lighting apparatus 1 can be easier. Accordingly, the working property becomes better. Due to the grips 32, 32, the bending stiffness of the base frame 2 in the lateral direction increases so that the bending of the lighting apparatus 1 can be suppressed.

The operation and effect of mounting the LED 3 inclinedly with respect to the base surface 21 as the mounting part for mounting the LED 3 and the erecting part 22 erecting on the base surface 21 is described in detail below.

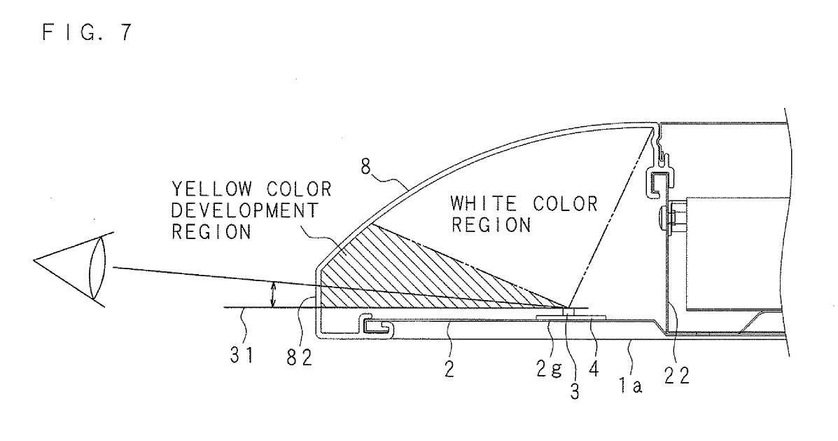

FIG. 6 is a schematic view illustrating the chromaticity of the illumination region illuminated by the LED 3 in the lighting apparatus according to the present embodiment. FIG. 7 is a schematic view illustrating chromaticity of the illumination region illuminated by the LED 3 in the comparative example. According to the comparative example shown in FIG. 7, the normal direction of a base surface 2g of the base frame 2 coincides with the normal direction of the LED substrate 4, the LED substrate 4 is arranged to face the base surface 2g in parallel.

According to the comparative example shown in FIG. 7, as the region marked with the hatching is shown in FIG. 7, the light in the yellow color development region is illuminated from the LED 3 to a part of the diffusion panel 8 at the side of the base frame 2. The yellow color development region is the illumination region in which the yellowish white light with chromaticity different from white chromaticity being visible due to the light emitted from the blue LED device and the excitation light emitted from yellow phosphor is radiated. According to the present embodiment described above, as shown in FIG. 6, since a general surface-mount type LED 3 is used and the yellowish white light as the light with different chromaticity, that is, the light in the yellow color development region is radiated in the direction of radiation close to the light-emitting surface 31 of the LED 3, the same LED 3 is also used in this comparative example.

Accordingly, as referring to the region marked with the hatching in FIG. 7, the light in the yellow color development region is radiated in the direction of radiation close to the light-emitting surface 31 of the LED 3. According to this comparative example, the LED substrate 4 is arranged to face the base surface 2g of the lighting apparatus 1 in parallel. The light-emitting surface 31 is formed such that it is parallel to the base surface 2g of the base frame 2. The light in the yellow color development region which is to be radiated to the side of the diffusion panel 8 in the direction of radiation close to the light-emitting surface 31 of the LED 3 is radiated directly to the diffusion panel 8 without being shielded between the LED 3 and the diffusion panel 8.

As a result, the light in the yellow color development region is visible to the user when the lighting apparatus 1 is observed from the side of the edge portion 82 of the diffusion panel 8. In addition, the yellow color development region is visible to the user in the illumination region radiated by the light in the direction of radiation close to the light-emitting surface 31 of the LED 3. That is, the color unevenness occurs due to the illumination of the light with different chromaticity.

On the other hand, as shown in FIG. 6, according to the lighting apparatus in the present embodiment, the LED substrate 4 is attached to the second inclined part 2d provided at the location which intersects with both the base surface 21 and the erecting part 22 so that the LED 3 is arranged inclinedly with respect to the base surface 21 and the erecting part 22. Therefore, the light-emitting surface 31 of the LED 3 is inclined with respect to the base surface 21 and the erecting part 22 and intersects with both the base surface 21 and the erecting part 22.

By attaching the LED 3 in this way, the light in the yellow color development region (the region marked with hatching in FIG. 6), where the light is radiated in the direction of radiation close to the light-emitting surface 31 of the LED 3, that is, the direction close to the mounting surface (the surface to be attached to the LED substrate 4 in FIG. 6) of the LED 3, is radiated along both the base surface 21 and the erecting part 22 from the second inclined part 2d. As configured described above, in the region (the region marked with hatching in FIG. 6) radiated by the light in the yellow color development region, that is, by the light with different chromaticity, the base surface 21 and the erecting part 22 as the shielding part for shielding the light with different chromaticity may be provided.

The light in the yellow color development region, which is radiated to the base surface 21 and the erecting part 22 in the direction of radiation close to the light-emitting surface 31 of the LED 3, that is, the periphery of the LED 3, does not reach the diffusion panel 8 because the light is shielded by the base surface 21 and the erecting part 22. Therefore, it is possible to reduce yellowish light caused by reflecting the light on the diffusion panel 8 in the yellow color development region. In other words, in the illumination region where the light from the LED 3 is illuminated, it is possible to reduce the formation of the illumination region where the light with different chromaticity is radiated by providing the base surface 21 and the erecting part 22 as the shield part. Accordingly, it is possible to reduce the color unevenness caused by mixing the region where the desired white light is recognized due to the light emitted from the blue LED device and the excitation light emitted from the yellow phosphor with the region where the white light in the yellow color development region different from the desired white light.

Additionally, according to the present embodiment, both of the base surface 21 and the erecting part 22 are formed as the shielding part for shielding the light with different chromaticity; however, as shown in the comparative example in FIG. 7, the LED 3 is not inclined with respect to the base surface 21 and the erecting part 22 as the mounting part, the LED 3 is arranged to be parallel to the base surface 21 so that only the erecting part 22 may be configured to shield the light with different chromaticity. Moreover, the LED 3 may be arranged to be inclined with respect to the base surface 21 and the erecting part 22 so as to make the light-emitting surface 31 of the LED 3 intersect with either the base surface 21 or the erecting part 22. In other words, as locating the LED substrate 4 at the tip edge of the base surface 21 or the erecting part 22, the LED 3 may be arranged to be inclined with respect to the base surface 21 and the erecting part 22. Therefore, the light with different chromaticity can be shielded by either the base surface 21 or the erecting part 22.

Moreover, other than configuring the shielding part in using a part of the base frame 2 as the frame body for locating a light source inside, the component other than the frame body may also be used as the shielding part in the present embodiment. Specifically, in the region where the light with different chromaticity is radiated in the diffusion part for diffusing the light emitted from the light source, mask, coating and the like for shielding the light with different chromaticity may also be provided. Additionally, in the region where the light with different chromaticity is radiated inside or outside of the frame body, the shielding part such as a partition screen or wall may be provided to reduce the formation of illumination region radiated by the light with different chromaticity.

However, the LED 3 is attached inclinedly with respect to the base surface 21 and the erecting part 22 in the present embodiment. Both of the base surface 21 and the erecting part 22 as a part of the base frame 2 as the frame body of the lighting apparatus can be used as the shielding part so that the shielding part is easy to be facilitated. Therefore, it is not necessary to provide another new shielding part so that the number of components can be reduced.

According to the present embodiment described above, the LED 3 as the light source is attached inclinedly to the base surface 21 and the erecting part 22 as the mounting part for the LED 3, however, the LED 3 may be configured to be attached parallel to the base surface 21. In this case, the shielding part such as a screen or coating arranged in the diffusion panel, a partition screen or wall arranged inside and outside of the frame body, a peripheral wall at the frame body is provided in the region where the light is radiated close to the light-emitting surface 31 of the LED 3 such as the periphery of the LED 3, that is, the region where the light with different chromaticity is radiated. Therefore, it is possible to shield the light with different chromaticity.

However, in the case where the LED 3 is arranged inclinedly with respect to the base surface 21, the light can be radiated from both sides of the lighting apparatus 1 towards outside diagonally as described above, it is favorable that the region of light distribution can be broadened as compared with the case where the LED 3 is arranged to face the base surface 2g in parallel as shown in the comparative example of FIG. 7.

In order to achieve plane emission in a state that the whole surface of the diffusion panel 8 emits light uniformly, it is necessary to meet the condition d≧p as d refers to the distance between the LED 3 and the diffusion panel 8, and p refers to the pitch (as the layout interval) of LEDs 3 mounted on the LED substrate 4. Accordingly, it is preferable to make the distance between the LED 3 and the diffusion panel 8 longer in order to meet the condition. According to the present embodiment, in the mounting part of the base frame 2 for the LED 3, the LED substrate 4 is provided at the second inclined part 2d in the concavity constituted by the first inclined part 2b, the second base surface 2c and the second inclined part 2d for the purpose of keeping the LED 3 distant away from the diffusion panel 8; therefore, it can be ensured that the distance between the LED 3 and the diffusion panel 8 is longer as compared with the case where the LED substrate 4 is provided at the base surface 2g on which the concavity is not provided as shown in the comparative example of FIG. 7. Accordingly, the construction of the present embodiment contributes to meeting the condition d z p for achieving uniform plane emission at the diffusion panel 8.

According to the present embodiment, the concavity is provided at the base surface 21 so as to keep the LED 3 distant away from the diffusion panel 8. In addition to this, the concavity may be provided at the erecting part 22 vertically arranged with respect to the base surface 21. Specifically, by providing a step at a part of the erecting part 22 at the side of the base surface 21 for the purpose of forming the concavity dented at the side of the power unit 6, and connecting the second inclined part 2d to the surface of the concavity at the side of the power unit 6, the LED substrate 4 on which the LEDs 3 are mounted can be attached to the second inclined part 2d. Therefore, the LED 3 can be arranged to keep distant away from the diffusion panel 8 as compared with the case where a concavity is only formed at the base surface 21. Moreover, the concavity may also be provided only at the erecting part 22.

In recent years, there is a tendency to reduce the number of LEDs 3 to be installed and lower cost by using the LED 3 with high output and huge capacity in comparison with the case where the LED with low output is used in achieving the similar luminance. In the case of using the LED 3 with high output, the number of the utilized LEDs 3 is reduced so that the pitch of the LEDs 3 mounted on the LED substrate 4 is larger. Therefore, it is necessary to make the distance between the LED 3 and the diffusion panel 8 longer to meet the condition d p in order to achieve the plane emission at the diffusion panel 8. According to the present invention, the plane emission can also be achieved by making the distance longer as described above even if the LED 3 with high output is used. Additionally, the present invention contributes to the cost reduction.

Furthermore, it is possible to keep the light-emitting surface 31 of the LED 3 distant away from the tip edges of the base surface 21 and the erecting part 22 by attaching the LED 3 to the concavity as described in the present invention. When an LED such the above-mentioned LED 3 for radiating the light with different chromaticity in the direction of radiation close to the light-emitting surface 31 is used, the illumination region radiated by the light with different chromaticity can be shielded by using a step due to the concavity. Therefore, the illumination region radiated by the light with different chromaticity is difficult to reach the tip edges of the base surface 21 and the erecting part 22.

In other words, it is possible to shield the light with different chromaticity by attaching LED 3 to the concavity formed at the base surface 21 or the erecting part 22, even if the dimension of the base surface 21 in the lateral direction or the dimension of the erecting part 22 in the normal direction of the base surface 21 is shortened. As compared with the case where the LED 3 is mounted inclinedly to the base surface 21 without forming a concavity, the light with different chromaticity in broader illumination region can be shielded by the base surface 21 or the erecting part 22.

According to the embodiment, it describes an example of shielding the yellowish white light caused by the excitation light emitted from yellow phosphor as the light with chromaticity different from the light with the desired chromaticity, the bluish white light with strong tint caused by the light emitted from the blue LED device can also be shielded so that it is possible to reduce the color unevenness caused by the influence of the light-emitting device.

Moreover, according to the embodiment, it describes that the so-called surface-mount type pseudo-white LED in which resin containing yellow phosphor seals a blue LED device is used as the light source. However, it is not limited to this case. Other types of LED such as an incandescent LED provided with a blue LED and both of yellow phosphor and red phosphor may also be used as the light source. In other words, all lighting apparatuses having a light source provided with an LED and phosphor for achieving the light with desired chromaticity are applicable to the present invention.

Furthermore, according to the embodiment, it describes an example that the light with different chromaticity is radiated in the direction of radiation close to the light-emitting surface of a general surface mount type LED. Other than the LED radiating the light with different chromaticity in the direction of radiation close to the light-emitting surface, for example, the present invention may be configured to use an LED irradiating the light with different chromaticity in the normal direction of the light-emitting surface of the LED and include a shielding part for shielding the light with different chromaticity radiated in the normal direction of the light-emitting surface of the LED. In other words, any direction of radiation of the light with different chromaticity is applicable to the present invention. Additionally, other than using the surface-mount type LED, other types of LED such as the so-called cannonball-type LED or the like may be used.

A straight-type lighting apparatus is explained in the embodiment. However, the shape of the lighting apparatus is not only limited to the straight-type. The so-called square-type or circular lighting apparatus may also be used.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-6. (canceled)

7. A lighting apparatus, comprising:
a light source including a light-emitting device and phosphor excited by light emitted from the light-emitting device to emit excitation light; and
a shielding part provided in a region where light with chromaticity different from chromaticity being visible due to the light from the light-emitting device and the excitation light is radiated, the shielding part shielding the light with different chromaticity among lights radiated from the light source.

8. The lighting apparatus according to claim 7, further comprising:
a frame body installing the light source inside,
wherein the shielding part is formed as a part of the frame body.

9. The lighting apparatus according to claim 8,
wherein the frame body includes a mounting part for mounting the light source and an erecting part vertically arranged with respect to the mounting part, and
the light source is attached inclinedly relative to the mounting part or the erecting part in order to shield the light with different chromaticity at the mounting part or the erecting part.

10. The lighting apparatus according to claim 9, further comprising:
a diffusion part diffusing light from the light source provided at the side radiated by the light from the light source,
wherein the frame body forms a concavity at the mounting part and/or the erecting part in order to keep the light source distant away from the diffusion part.

11. A lighting apparatus, comprising:
a light source including a light-emitting device and phosphor excited by light emitted from the light-emitting device to emit excitation light; and
a shielding part provided in an illumination region illuminated by the light source, in order to reduce formation of an illumination region illuminated by light with chromaticity different from chromaticity being visible due to the light from the light-emitting device and the excitation light, the shielding part shielding the light with different chromaticity.

12. The lighting apparatus according to claim 11, further comprising:
a frame body installing the light source inside,
wherein the shielding part is formed as a part of the frame body.

13. The lighting apparatus according to claim 12,
wherein the frame body includes a mounting part for mounting the light source and an erecting part vertically arranged with respect to the mounting part, and
the light source is attached inclinedly relative to the mounting part or the erecting part in order to shield the light with different chromaticity at the mounting part or the erecting part.

14. The lighting apparatus according to claim 13, further comprising:
a diffusion part diffusing light from the light source provided at the side radiated by the light from the light source,
wherein the frame body forms a concavity at the mounting part and/or the erecting part in order to keep the light source distant away from the diffusion part.

15. A lighting apparatus, comprising:
a light source including a light-emitting device and phosphor excited by light emitted from the light-emitting device to emit excitation light; and
a shielding part provided in an illumination region illuminated by the light source, in order to reduce a color unevenness caused by an illumination of light with chromaticity different from chromaticity being visible due to the light from the light-emitting device and the excitation light, the shielding part shielding the light with different chromaticity.

16. The lighting apparatus according to claim 15, further comprising:
a frame body installing the light source inside,
wherein the shielding part is formed as a part of the frame body.

17. The lighting apparatus according to claim 16,
wherein the frame body includes a mounting part for mounting the light source and an erecting part vertically arranged with respect to the mounting part, and
the light source is attached inclinedly relative to the mounting part or the erecting part in order to shield the light with different chromaticity at the mounting part or the erecting part.

18. The lighting apparatus according to claim 17, further comprising:
a diffusion part diffusing light from the light source provided at the side radiated by the light from the light source,
wherein the frame body forms a concavity at the mounting part and/or the erecting part in order to keep the light source distant away from the diffusion part.
